(19) United States
(12) Patent Application Publication
(10) Pub. No.: US 2022/0212192 A1
(43) Pub. Date: Jul. 7, 2022

(54) Microfluidic Device for High-Throughput Screening of Tumor Cell Adhesion and Motility

(71) Applicant: Northeastern University, Boston, MA (US)

(72) Inventors: Tania KONRY, Boston, MA (US); Giovanni UGOLINI, Allston, MA (US)

(21) Appl. No.: 17/613,138

(22) PCT Filed: Jun. 1, 2020
(86) PCT No.: PCT/US2020/035569

§ 371 Date: Nov. 22, 2021

Related U.S. Application Data
(60) Provisional application No. 62/856,053, filed on Jun. 1, 2019.

(51) Int. Cl. B01L 3/00

(52) U.S. Cl. CPC B01L 3/502738; B01L 3/502784; B01L 2400/0487; B01L 2300/0887; B01L 2200/0673; B01L 2400/0638

(57) ABSTRACT

Microfluidic devices and methods are provided for high-throughput generation, culturing, and analysis of cell spheroids, with subsequent isolation of selected cell spheroids for further analysis or isolation and expansion of cells from the spheroids. Any desired types of cells and matrices can be combined to form the cell spheroids and used to screen drugs and immunotherapy agents or methods, including in a personalized medicine format. Cell spheroids also can be cultivated and analyzed under hypoxic conditions. A particular advantage of the technology is the ability to isolate, enrich, and/or expand cells identified as having, or induced to have, desirable properties, such as immune cells that can be produced ex vivo and returned to the patient to combat a tumor or pathogen in vivo.

### CROSS REFERENCE TO RELATED APPLICATIONS

This application claims the priority of U.S. Provisional Application No. 62/856,053, filed 1 Jun. 2019, the whole of which is hereby incorporated by reference.

### BACKGROUND

Cells from a heterogeneous population can be isolated and analyzed using cell spheroids. High-throughput devices exist which can provide a microarray of such spheroids. However, isolation of one or more cells from such an array is difficult with available methods.

Some previous systems employing isolated cells embedded in 3D matrices have suffered from limited cell adhesion and motility. The use of more biomimetic matrices has required complex equipment and control systems to merge droplets containing cell spheroids. Fluorescence-activated droplet sorting (FADS) has been used to select and isolate hydrogel-based or liquid droplets; however, this approach requires complex and costly equipment, is limited to use of fluorescent markers, and does not allow on-demand retrieval of individual cells or cell spheroids. No previous approach allows the selection and expansion of a fraction of immunotherapeutic cells with desired functional characteristics, such as enhanced killing potential or fast action.

Thus, there is a need for improved devices and methods that enable fast, convenient, and on-demand isolation of individual cell spheroids or groups of cells identified during screening as having useful biological properties.

### SUMMARY

The present technology provides microfluidic devices and methods of using the devices for high-throughput generation, culturing, and analysis of cell spheroids, with subsequent isolation of selected cell spheroids for further analysis or isolation and expansion of cells from the spheroids. The devices can form cell spheroids which can serve as three-dimensional biomimetic models of biological tissue including a tumor. Any desired types of cells and matrices can be combined to form the cell spheroids and used to screen drugs and immunotherapy agents or methods, including in a personalized medicine format. High throughput screenings can be conducted to investigate, for example, the ability of natural killer cells to kill tumor cells of a patient, and the impact of drugs and/or immunotherapeutic interventions on killing effectiveness or kinetics, as well as on the motility and adhesion ability of the tumor cells before and/or after drug treatment and/or immunotherapeutic intervention. Assays carried out with the present technology can include fluorescence labeling, such as with antibody- or aptamer-coated labeled microbeads, to identify cell types or molecules secreted by the cells. A particular advantage of the technology is the ability to isolate, enrich, and/or expand cells identified as having, or induced to have, desirable properties, such as immune cells that can be produced ex vivo and returned to the patient to combat a tumor or pathogen in vivo.

The technology can be further summarized in the following list of features.

1, A microfluidic device for the analysis and isolation of a plurality of cell spheroids, the device comprising:

a first layer comprising an array of microchambers or docking sites for storing and analyzing a plurality of cell spheroids in a liquid medium;

a second layer comprising a plurality of pneumatic channels, wherein the second layer overlays the first layer; and

one or more valves fluidically connected to each of said microchambers or docking sites; wherein the valves are disposed within said first layer and/or within said second layer; wherein each valve is selectively actuatable through one of said pneumatic channels, and wherein actuation of one or more of said valves opens a pathway for removal of a cell spheroid from the microchamber or docking sites fluidically connected to the one or more valves.

2. The microfluidic device of feature 1, wherein the first layer further comprises a cell spheroid production module; wherein the cell spheroid production module comprises:

a plurality of inlets for accepting solutions, cell suspensions, or oil;

a plurality of microfluidic channels fluidically connected to said inlets, said plurality of microfluidic channels comprising an oil channel and one or more cell suspension channels; and

a nozzle for forming aqueous microdroplets in oil, the nozzle inlet fluidically connected to said oil channel and at least one of said one or more cell suspension channels, and the nozzle outlet fluidically connected to said array of microchambers or docking sites.

3. The microfluidic device of feature 1 or feature 2, wherein two, three, or four valves are fluidically connected to each microchamber or docking site.
4. The microfluidic device of any of the preceding features, wherein the valves comprise membrane valves.
5. The microfluidic device of any of the preceding features, comprising a membrane disposed between the first and second layers of the device.
6. A microfluidic device for the analysis of a plurality of cell spheroids under a controlled atmosphere, the device comprising:

a first layer comprising an array of microchambers or docking sites for storing and analyzing a plurality of cell spheroids in a liquid medium;

a second layer comprising a plurality of pneumatic channels, wherein the pneumatic channels are coupled to at least one inlet and an outlet for the supply of gas to flow through the pneumatic channels, and wherein the second layer overlays the first layer; and

a gas-permeable membrane disposed between the first and second layers, wherein one or more of the pneumatic channels overlap with one or more said microchambers or docking sites, thereby enabling flow of gas from the pneumatic channels through the gas-permeable membrane and into said microchambers or docking sites, thereby providing a controlled atmosphere for cell spheroids disposed in said microchambers or docking sites.

7. The microfluidic device of feature 6, wherein the first layer further comprises a cell spheroid production module; wherein the cell spheroid production module comprises:

a plurality of inlets for accepting solutions, cell suspensions, or oil;

a plurality of microfluidic channels fluidically connected to said inlets, said plurality of microfluidic channels comprising an oil channel and one or more cell suspension channels; and

a nozzle for forming aqueous microdroplets in oil, the nozzle inlet fluidically connected to said oil channel and at least one of said one or more cell suspension channels, and the nozzle outlet fluidically connected to said array of microchambers or docking sites.

8. The microfluidic device of feature 6 or feature 7, wherein the second layer further comprises a gas gradient generator that provides a gradient of at least one component of said controlled atmosphere across the array of microchambers or docking sites.
9. The microfluidic device of any of the preceding features, further comprising, one or more cell spheroids disposed in a microchamber or docking site of the array.
10. A system comprising the microfluidic device of feature 1 or feature 6 and a separate cell spheroid production device comprising:

a plurality of inlets for accepting solutions, cell suspensions, or oil;

a plurality of microfluidic channels fluidically connected to said inlets, said plurality of microfluidic channels comprising an oil channel and one or more cell suspension channels; and

a nozzle for forming aqueous microdroplets in oil, the nozzle inlet fluidically connected to said oil channel and at least one of said one or more cell suspension channels, and the nozzle outlet fluidically connected to an outlet;

wherein said outlet is capable of providing a plurality of cell spheroids from said cell spheroid production device through a fluidic coupling to said array of microchambers or docking sites of the microfluidic device.
11. A system comprising the microfluidic device of any of features 1-5 or the system of feature 10, further comprising a controlled pneumatic pressure source connected to one or more of said pneumatic channels, the pressure source capable of selectively actuating one or more of said valves.
12. A method of analyzing a plurality of cell spheroids, the method comprising:

(a) providing the microfluidic device of any of features 1-5, or the system of feature 10 or 11; an oil; a first aqueous suspension comprising one or more first cell types and one or more of a polymerization mediator or a polymerization precursor, and an extracellular biopolymer; and a second aqueous suspension comprising one or more of a polymerization mediator or a polymerization precursor, an extracellular biopolymer, and optionally one or more second cell types;

(b) inducing flow of said oil, first aqueous suspension, and second aqueous suspension in said device, whereby aqueous microdroplets are formed in the oil, each aqueous microdroplet comprising a single polymerized cell spheroid, each spheroid comprising a gel-forming polymer, one or more cell types, and said extracellular biopolymer;

(c) docking each spheroid in a unique microchamber or docking site of the array of the device; and

(d) analyzing one or more cell spheroids within the array for a period of time.

13. The method of feature 12, wherein one of said first and second cell types is a tumor cell.
14. The method of feature 12 or feature 13, wherein one of said first and second cell types is an immune cell.
15. The method of any of features 12-14, wherein the first and/or second aqueous suspensions comprises an agent suspected of altering an interaction between the first and second cells or a functional property of said first or second cells.
16. The method of any of features 12-15, further comprising pneumatically activating one or more of said first and/or second valves, whereby one or more cells or cell spheroids is collected from a microchamber or docking site of the device.
17. The method of feature 16, wherein said collected cell spheroid is removed from the device for further analysis, cultivation, expansion, or use in a therapeutic method.
18. The method of any of features 12-17, wherein the spheroids are analyzed in step (d) for ability of an immune cell to bind or kill a cancer cell, or for a cancer cell to adhere to other cells of the spheroid, or for a cancer cell to migrate within the spheroid or to leave the spheroid.
19. A method of analyzing a plurality of cell spheroids under a controlled atmosphere, the method comprising:

(a) providing the microfluidic device of any of features 6-9, or the system of feature 10 or 11; an oil; a first aqueous suspension comprising one or more first cell types and one or more of a polymerization mediator or a polymerization precursor, and an extracellular biopolymer; and a second aqueous suspension comprising one or more of a polymerization mediator or a polymerization precursor, an extracellular biopolymer, and optionally one or more second cell types;

(b) inducing flow of said oil, first aqueous suspension, and second aqueous suspension in said device, whereby aqueous microdroplets are formed in the oil, each aqueous microdroplet comprising a single polymerized cell spheroid, each spheroid comprising a gel-forming polymer, one or more cell types, and said extracellular biopolymer;

(c) docking each spheroid in a unique microchamber or docking site of the array of the device; and

(d) analyzing one or more cell spheroids within the array for a period of time.

20. The method of feature 19, wherein one of said first and second cell types is a tumor cell.
21. The method of feature 19 or feature 20, wherein one of said first and second cell types is an immune cell.
22. The method of any of features 19-21, wherein the first and/or second aqueous suspensions comprises an agent suspected of altering an interaction between the first and second cells or a functional property of said first or second cells.
23. The method of any of features 19-22, further comprising providing a controlled atmosphere through the pneumatic channels and optional gas gradient former of the second layer to cell spheroids disposed in one or more microchambers or docking site of the device.
24. The method of feature 23, wherein said controlled atmosphere is hypoxic.

As used herein, the term “microstructure” or “microchannel” refers to a structure having at least one dimension in the microscale, that is, at least one dimension or structure having a size from about 0.1 to about 1000 micrometers. The term “microstructure” includes, but is not limited to, microchannels, microtubes, microparticles, microvalves, microdroplets, microlayers, and cell spheroids.

As used herein, “cell spheroid” refers to any generally round collection of cells bound to a substantially spherical polymer gel or scaffold. Cell spheroids of the present technology can be formed in a microdroplet, which is itself formed within a mmicrofluidic device. The size of a cell spheroid can vary, for example from about microns to about 1000 microns in diameter or from about 50 μm to about 900 μm in diameter, and is substantially determined and delimited by the size of the polymer scaffold to which the cells are bound, which itself can be determined by the size of aqueous microdroplets formed in the microfluidic device. In general, larger cell spheroids (e.g., >500 μM) have three layers: a core which may be necrotic, a middle layer of viable and substantially stationary cells, and an outer layer of migrating cells. The present technology can be utilized to isolate individual microdroplets containing any ingredients. Microdroplets can form cell spheroids after polymerization of the microdroplets in the microchambers or microchannels of the devices herein. The cell spheroids of the present technology can mimic gradients of substances within a tissue, cell composition, and heterogeneity of a tumor mass, thereby also mimicking resistance to drug penetration providing more realistic drug response. The technology can be used to analyze cell spheroids by their perfusion with solutions containing, for example, a virus, an antibiotic, an anti-cancer agent, a radioactive (chemotherapy) agent, an anti-fungal agent, another cell, a test chemical (small molecule, peptide, oligonucleotide, antibody, aptamer), or a microbe.

A variety of polymers can be used to form a gel that stabilizes the cell spheroids. One suitable polymer is alginate, which can be supplied as a soluble solution of sodium alginate, into which is mixed, at the nozzle of a microfluidic device during droplet formation, a CaCl₂) solution which serves as polymerization mediator. The Ca²⁺ ions (or any other suitable and nontoxic polymerization mediator) cause the formation of a network of polymerized alginate fibers within the droplets within minutes after mixing at the nozzle, resulting in formation of a polymer scaffold for cell attachment. Hydrogels containing peptides can be used as polymers, either alone or with alginate, chitosan, or other polymers. For example, PuraMatrix™ is a peptide polymer manufactured by Corning® for use in creating 3D micro-environments for cell culture. Other suitable polymers and corresponding polymerization mediators include collagen (polymerized by pH elevation of a monomeric collagen solution), agarose (polymerized by temperature reduction), polyethylene glycol (PEG, polymerized using UV light), and chitosan. A polymerization mediator in the present technology can be a chemical agent (such as Ca²⁺), condition (such as pH), or a physical agent (such as UV light, temperature change, or mechanical stimulus).

Devices used for fluid (liquid or gas) delivery into or out of a microfluidic device vacuum device of the present technology include syringe pumps, microflow variable-speed peristaltic pumps, micro-diaphragm pumps, stepper motor driven pumps, electroosmotic pumps, siphons, piezoelectric pumps, acoustic streaming pumps, on-chip pumps, thermal pumps, and vacuum pumps. Examples of vacuum pumps are suction pumps with regulators or bypass valves, water or liquid driven vacuum pumps, positive displacement pumps, diaphragm, venturi, and piston pumps. A pump or vacuum device can be attached to ports of a microfluidic device using tubing. Tubing or microtubing utilized in connection to a microfluidic device can be fabricated from, for example, fused silica, silicone, polyether ether ketone (PEEK), or various plastics, metals, and alloys. A pump or vacuum device can have variable output and can be microprocessor controlled. Positive or negative pressure devices can be automated and can be computer and software controlled.

As used herein, “consisting essentially of” does not exclude materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

As used herein, the term “about” includes values close to the stated value as understood by one of ordinary skill. For example, the term “about” can refer to values within 10%, 5%, or 1%, of the stated value.

### BRIEF DESCRIPTION OF DRAWINGS

FIG. 1 shows a schematic representation of a two-layer microfluidic device with docking site array and valve structure. The first layer contains microchambers or docking sites for cells or cell spheroids, and the second layer contains pneumatic channels for control of valves located in the first and/or second layer which control fluid flow in the first layer that can be used to harvest individually selected cells or cell spheroids located in the microchambers or docking stations.

FIG. 2 shows a two-dimensional layout of a microfluidic device for forming cell spheroids and analyzing them in a microchamber array. This configuration is one possible alternative to the configuration of the first layer shown in FIG. 1.

FIG. 3A shows the device of FIG. 2 with its inlet and outlet ports labeled to correspond to the solutions input or output to/from the device in an exemplary use to prepare, analyze, and collect cell spheroids. FIGS. 3B-3E show the open (light circles) and closed (dark circles) condition of each of the inlets and outlets of the device during formation of aqueous microdroplets (3B), loading of the microchamber array (3C), perfusion with Ca²⁺ solution to polymerize the matrix and form gelled spheroids (3D), and release of cells or cell spheroids from the array (3E).

FIG. 4 shows a schematic representation of a pneumatic valve for use in a microfluidic device.

FIGS. 5A-5C show fluorescence microscope images of on-chip lymphoma spheroids showing different cell types labeled with different fluorescent dyes. The labeling allows quantification of cell proliferation in the spheroid. FIG. 5A shows the spheroid on day 1; FIG. 5B shows the spheroid at day 5; FIG. 5C shows dead cells in a spheroid at day 5 in the array (tip of arrow). FIG. 5D shows the percent dead Non-Hodgkins lymphoma (NHL) cells in microfluidic device-generated spheroids (MF Spheroid) compared with similar cells cultured in monolayer culture or 3D scaffolds.

FIG. 6A shows a schematic representation of a two-layer microfluidic device for exposing cell spheroids in a microchamber array to a gradient of atmosphere across the array. The first layer (spheroid array layer) generates cell spheroids and loads them into microchambers in an array. In the second layer (gas gradient layer) normal air and N₂ inlets feed into a gas gradient generator, which supplies a gas gradient across the array from top (100% N₂) to bottom (100% air). The gas supplied at N₂ and air inlets can be exchanged with any desired gas or gas mixture. FIG. 6B shows a cross-sectional view of a two-layer microfluidic device for exposing cell spheroids in a microchamber array to a gas gradient. The two layers of the device are separated by a gas-permeable membrane.

FIGS. 7A-7C show the effects of hypoxia on cell spheroids.

### DETAILED DESCRIPTION

The present technology is directed to a microfluidic platform for high-throughput generation, analysis, and on-demand isolation of 3D cell-containing spheroids. The technology is also capable of isolating aqueous droplets suspended in an oil medium, wherein the aqueous droplets can comprise one or more cells or a cell spheroid. The technology is versatile with respect to cell spheroid and droplet size and cellular or chemical composition.

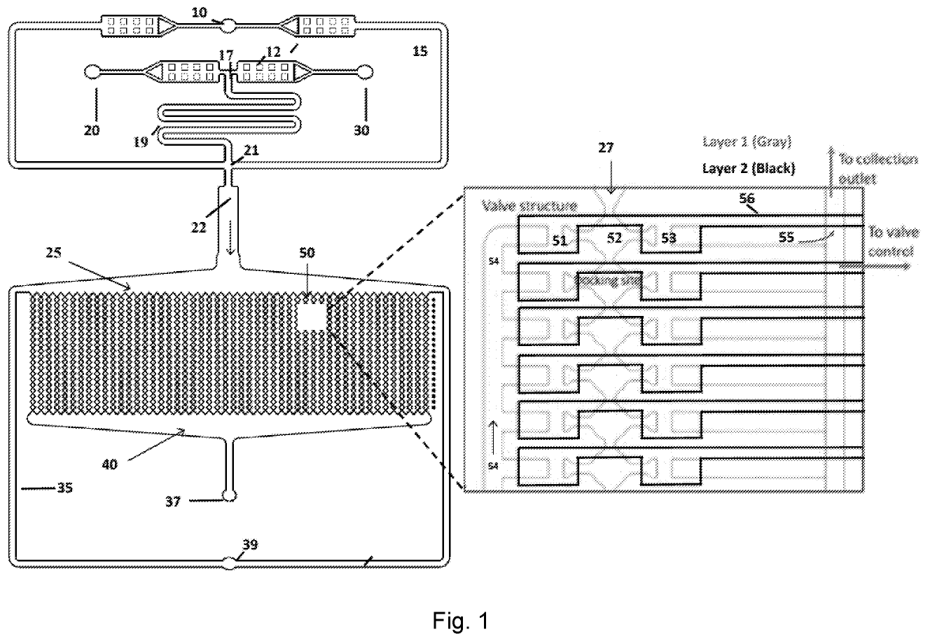

The present technology provides a microfluidic device that can be fabricated through standard soft photolithography. A microfluidic device for cultivation, analysis, and/or isolation of cells and/or cell spheroids can have two microfabricated layers, each having a network of microfluidic channels, chambers, and other structures, wherein the two layers are interconnected at one or more points. An embodiment of such a device is shown in FIG. 1. A first layer can carry out the formation, cultivation, and analysis of cell spheroids, preferably in a microarray of microchambers arranged in a two-dimensional rectangular array of rows and columns. The first layer can include any or all of the following: one or more first inlets for an oil, one or more second inlets for an aqueous suspension of cells, which can also contain a matrix forming material such as fibrinogen, one or more polymerization mediators, one or more test compounds or other compounds, and/or one or more polymerization precursors. The first layer can also include one or more third inlets for a polymerization mediator, thrombin, an aqueous suspension of cells, one or more test compounds or other compounds, and/or a polymerization precursor. The inlets can be further connected to first, second, and third microchannels. The first layer can include a nozzle formed by a T-shaped intersection of two or more of the first, second, and third microchannels, and an incubation chamber containing a plurality of microchambers or docking sites configured in a two-dimensional array of any desired geometry or arrangement of the microchambers/docking sites. The nozzle is capable of producing aqueous droplets suspended in the oil; the aqueous droplets can contain, for example, cells, fibrinogen, thrombin, and alginate, and the cells together with fibrinogen, thrombin, alginate, or other biopolymers can form cell spheroids within the droplets. The incubation chamber is fluidically connected to the nozzle and is capable of accepting and delivering the aqueous droplets individually into microchambers. If desired, the aqueous droplets can be gelled after collection into the microchambers or before. The incubation chamber can comprise one or more windows for monitoring one or more of the microchambers by various means including light microscopy, including fluorescence microscopy, which can provide quantitative analysis or imaging analysis using a photodetector or camera.

In the first layer, the generated droplet volume and size (i.e., diameter) can be controlled by the flow rate. For example, the generation of hydrogel-containing droplets can be determined by on-chip co-flow of a fibrinogen solution (e.g., 0.1-50 mg/mL) and a thrombin solution (e.g., 0.3-10 μg/mL). The two aqueous solutions may contain cells for biological assays and are separately introduced into the chip, and their dedicated microchannels form a junction to obtain mixing; another junction can be provided further downstream (e.g., 100 μm-1 mm downstream of the first junction) with oil-dedicated microchannels for water-in-oil droplet generation. The droplets then can flow into an array of docking sites or microchambers where cell culture can be performed and observed, for example by light microscopy, or analyzed for the presence or amount of a detectable label such as a dye that absorbs light of a certain wavelength or that exhibits fluorescence.

Each docking site or microchamber in the array can be designed to have at least one lateral collection channel in addition to the main connection to the incubation chamber array (FIG. 1). The collection channel features at least one valve structure located in a second layer close to the docking site, such as above or below the docking site in the plane of the second layer. In the second layer, at least one valve structure is positioned in or near the corresponding location of each docking site and connected to a pneumatic inlet. In some embodiments, the valve or a portion of the valve can span both the first and second layers, or the valve is entirely in the first layer with pneumatic channels for activating the valve located in the second layer. When required, the valve or valves can be actuated selectively, based on the layout of pneumatic channels in the second layer and their connection to ports on the device providing connection to a pressure or vacuum source. The network of pneumatic channels can control one or more valves, such that fluid flow occurs only at a single selected docking site or microchamber, or at a group of linked or selected docking sites or microchambers. When activated through the pneumatic microchannel system of the second layer, fluid flow can displace a desired droplet, or contents of the selected microchamber or docking station, including any cells or cell spheroids contained therein, towards a fluid outlet for collection. The fluid outlet and microfluidic channels leading thereto can be located within the first layer or the second layer. After collection of fluid and/or one or more cells or cell spheroids, further tests can be run on the collected material, or cell expansion can be performed off-chip in microwells or other suitable cell culture vessels, or on-chip in liquid droplets supplemented at appropriate times with additional culture medium.

In some embodiments, each microchamber can be separately perfused by using one or more additional microchannels or valves such that the microenvironment of each microchamber is individually controlled after a spheroid or droplet is docked in a microchamber.

The contents of each microchamber or docking site can be isolated by one or move valves connected to the microchamber or docking site, or nearby vicinity thereof. When the one or move valves are opened, through pneumatic or other means, the contents of the microchamber or docking site are displaced by flow from a laterally connected collection channel. The flow displaces the contents of the microchamber or docking site, moving the contents to a collection outlet. Thus, the contents of each docking site or microchamber can be isolated on demand, enabling convenient and rapid material for subsequent analysis. The contents of each microchamber can be, for example, a single cell in an aqueous microdroplet, or a single cell spheroid containing several cells of one or more different types, optionally including substances secreted by cells in the spheroid, as well as the matrix in which the cell spheroid is embedded. Any of these components can be subjected to analysis by any desired chemical, biochemical, molecular biological, photometric, and/or imaging analysis.

The microfluidic devices of the present technology can be used to carry out improved cancer therapy/immunotherapy screening. For example, cell spheroids containing cancer cells together with immune cells can be cultivated and analyzed for effective killing of the cancer cells by the immune cells under different conditions, and cells or spheroids resulting in positive results (i.e. effective or rapid killing of cancer cells by immune cells) can be isolated for further study (e.g., presence of markers, genomic or proteomic analysis, mRNA analysis) or cultivation for further analysis or therapeutic use.

The present technology provides a low-cost, on-demand cell retrieval system, using devices that can be fabricated inexpensively using soft lithography and provide simple pneumatic control (e.g., using a vacuum source) of valves that allow isolation of selected individual cell spheroids, cells, groups of cells, or aqueous microdroplets and their contents. For comparison, FADS methodology requires expensive, bulky equipment including lasers, kV electrical amplifiers, photomultiplier tubes, a dedicated microscope, and complex optical elements. Such systems are complex, expensive, and potentially dangerous.

Using devices of the present technology, hydrogel droplets can be generated having, for example, picoliter volume, which allow for analysis of cell adhesion, motility, and migration and collection of cells having desired properties of cell adhesion, motility, and/or migration. Cross-linking of matrix components within cell spheroids can be controlled and allowed to occur only within the microfluidic device based on mixing of solutions within the device, determined by design and not requiring complex equipment for droplet handling or droplet merging. The droplets can be monitored and selectively retrieved on demand at different time points for further tests, expansion of cells, or subsequent microfluidic handling requiring only simple pneumatic controls, and without the need for triggering by a fluorescent marker.

The present technology offers several advantages over previous technology for studying cell interactions using cell spheroids. For example, it enables high-throughput evaluation, at the level of single cells or multiple cells in a three-dimensional environment, of the efficacy of immune cell therapies, drugs, delivery systems, antibodies, and combinatorial therapies for killing solid tumors in an environment simulating that found in vivo. The technology allows cell adhesion, cell migration, and/or cell motility to be investigated, particularly as it relates to tumor cells in a tissue, such as a tumor. The technology also allows on-demand isolation of individual cells or cell spheroids when desired, such as after immune cells therein have been stimulated or tumor cells have been inhibited.

Cell spheroids can be formed by first forming a series of aqueous droplets (or microdroplets) in an oil (such as mineral oil, silicone oil, or a vegetable oil, the oil optionally including a low concentration of a surfactant to improve flow characteristics) using a nozzle in a microfluidic device. The nozzle can contain a T-shaped junction. The droplets can be substantially spherical, and their aqueous contents can include, prior to polymerization to form a gelled cell spheroid, a suspension of one or more different types of individual cells and an initially non-polymerized form of a polymer suitable for forming a gel once the microdroplets are docked in individual microchambers or at individual docking stations. The gel can mimic fibrous elements of the extracellular matrix of a mammalian tissue. The droplets may also include a polymerization mediator or catalyst, which is a chemical agent that reacts with a polymer precursor in the droplet to form a 3D polymer scaffold within the droplet, such as a microbead composed of an essentially spherical network of fibers. The cells of a spheroid can be any type of cell including, for example, eukaryotic and/or prokaryotic cells, tumor cells (including tumor stem cells and model tumor cells), cells of a cell line or culture, cells from a patient, immune cells such as lymphocytes or macrophages, stromal cells, or fibroblasts. The cells can adhere to the polymer scaffold and grow, differentiate, and/or proliferate within the droplet to form a cell spheroid.

In different embodiments, the microfluidic devices or systems of the technology can include, for example, additional device layers having specialized microfluidic channels, chambers, valves, pneumatic controls, ports, and the like, different valve configurations, or different valve actuation schemes or mechanisms. For example, the incubation chamber containing microchambers or docking sites, with valves configured for isolation of the contents, can be configured as a separate device, with droplets or spheroids generated in separate device and provided to the incubation chamber device. Pneumatic control of valves isolating the microchambers can include electronic valve controls. The valves or entire device can be controlled by a microprocessor, memory, and software.

The microfluidic devices of the present technology can be fabricated through standard photo/soft-lithography or by any method known in the art. In a “soft” lithography method a template for the device is patterned and the device is then cast from polydimethylsilane (PDMS) and peeled from the template. The PDMS portion contains the channels and other structural and fluid handling features of the device. The PDMS portion can be subjected to plasma treatment and then adhered to glass, such as a glass microscope slide. Holes can be drilled into the PDMS portion of the device as appropriate to provide inlets and outlets. Additional layers can be applied together with interfacing layers, which can contain surfaces with diaphragms, inserts, and valves. For the present technology at least two microfabricated layers are required. An additional layer under the two-dimensional microchamber array can be added to provide circuits for actuation of valves in the two-dimensional array. A membrane, such as a thin, gas-permeable PDMS membrane, optionally can be applied over the two-dimensional array to provide a supply surface for a gas, including a gas gradient, which can be applied to the spheroids in the array.

In the device depicted in FIG. 1, inlet 10 is intended for the introduction of an oil phase. The oil inlet is connected via a short microchannel to optional filters 12, through oil channel 15, to nozzle 21. Inlets 20 and 30 can be used for cell suspensions or other solutions containing components needed to form the cell spheroids, such as polymerization initiator, polymerization precursor (e.g., fibrinogen, thrombin, alginate, or other polymerizable or gel-forming biopolymers), matrix components (e.g. collagen, elastin, glycosaminoglycans, proteoglycans), test compounds, labeled detection molecules or microbeads, and the like. The two cell suspensions or solutions together provide all components needed to form the spheroids, but each solution is missing at least one component required for polymerization, which is provided by the other solution to initiate polymerization upon mixing at junction 17. Serpentine cell suspension channel 19 promotes mixing of the cell suspension or solution components prior to reaching nozzle 21. At nozzle 21, aqueous microdroplets are formed in the oil phase and move into collection zone 22, where they accumulate and move on to microchamber array 25.

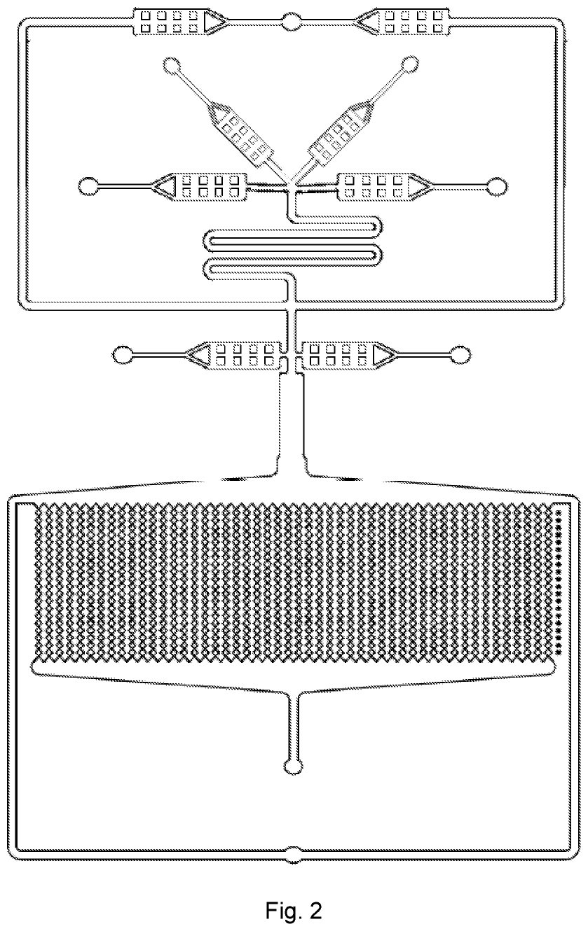

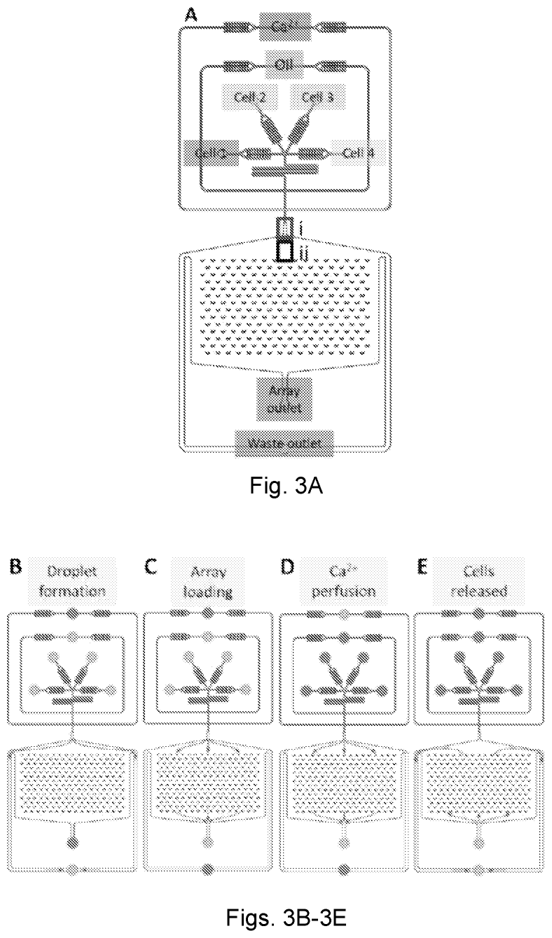

It should be noted that many different device configurations are possible for forming cell-containing aqueous microdroplets in oil, using different types and number of types of cells and other components. Any suitable configuration can be used in the present technology. For example, FIG. 2 shows another embodiment of such a device, which is configured for mixing four different cell suspensions and/or solutions; exemplary flow patterns through such a device during different phases of cell spheroid formation, cultivation, and collection are shown in FIGS. 3A-3E. Further such device configurations can be found in WO2015/200832A1, which is incorporated by reference herein in its entirety. In some configurations, the cell spheroids are formed on a first device or chip and transferred to a second device or chip containing a two-dimensional array of microchambers for incubation and analysis of the spheroids. In other configurations, the cell spheroids are formed, incubated, and analyzed all within a single device or chip.

Returning to FIG. 1, the aqueous microdroplets collected within array 25 can form cell spheroids upon the polymerization of the polymerization precursor together with the polymerization initiator and together with any optional matrix components. Following polymerization, the oil can be washed out of the microchamber array and replaced with a culture medium for incubation and analysis over any desired period of time. Spheroids stationed in the microchambers can be perfused by flowing medium in through perfusion inlet port 39 and out through outlet port 37. The cell spheroids can be monitored using a suitable technique, such as fluorescence microscopy, another form of optical microscopy, a cell viability assay, or other method to determine a state of interest of the cells. The microfluidic device can be used to screen different antitumor agents for killing action against tumor cells of a particular patient, such as a human or other mammalian subject, to determine an effective agent or combination of agents for chemotherapeutic intervention for the patient. The device also can be used for studies of cell-cell interactions, cell-matrix interactions, or for the development of new antitumor agents or immunotherapy agents or procedures.

Following incubation and analysis of the cell spheroids in the microchamber array, selected spheroids can be collected for further analysis and/or cell collection and expansion by conventional cell culture, and even for administration to a patient as a therapeutic product, or used to produce a therapeutic product. The expanded portion at the right side of FIG. 1 shows an expanded schematic view of the two-layer structure of array portion 50. Cells or cell spheroids are incubated in an array of microchambers or docking sites 52. Pneumatic channels 56 control valves 51 and 53, which can remain closed during incubation and analysis of the cells in microchamber 52, and can be opened to collect cells or cell spheroids from selected microchambers under control of a valve control unit, which can be located off the device. When the valves are open, a solution or culture medium can be flowed through flushing inlet channel 54, into the microchamber or docking site area, and the cells or spheroids flushed out to through flushing outlet channel 55 a collection vessel.

The valves used to control flow for collection of cells and cell spheroids can be pneumatic valves controlled by pneumatic channels in a second layer of the microfluidic device. An example of such a pneumatic valve is shown in FIG. 3. In the valve of FIG. 3, a thin PDMS membrane is acted upon by pressure in the pneumatic channel above the valve. Such a PDMS membrane can be installed between first and second layers of the microfluidic device, such that pressure in the layer above the membrane controls the configuration of the membrane within the lower part of the valve in the layer below the membrane. In the open configuration of the valve, pressure in the pneumatic channel is sufficiently low that the PDMS membrane is relaxed and permits fluid flow through the valve. In the closed configuration, pressure in the pneumatic channel is high enough to expand the PDMS membrane into the valve, blocking fluid flow through the valve. Other valve configurations and principles of operation also can be used. Valves can be present within the first (microfluidic) layer of the device, within the second (pneumatic) layer of the device, or partly within each layer. Pneumatic valves for use in microfluidic devices and systems for their control are known and capable of use in the present technology. For example, see K. Brower, et al., An open-source, programmable pneumatic setup for operation and automated control of single- and multi-layer microfluidic devices, Hardware X 3 (2018) 117-134, which is hereby incorporated by reference in its entirety.

The present technology also methods of using the devices and systems disclosed herein, such as for screening of tumor cell adhesion and/or motility, as well as methods of inhibiting or promoting cell adhesion and/or motility of tumor cells or other cells.

### EXAMPLES

### Example 1: Generation of Cell Spheroids

Hydrogel-based spheroids containing breast cancer cells were formed in microfluidic droplets using a device as described in FIG. 2 and a protocol as described in FIGS. 3A-3E. MCF-7 breast cancer cells were co-encapsulated with other cell types to mimic the composition of human breast cancer tissue. The additional cells were immune peripheral blood derived T cells, dendritic cells, monocyte/macrophages, stroma (non-tumorigenic epithelial cell line MCF 10A), and fibroblasts (human mammary gland breast fibroblasts (CCD-1129SK)). Each cell type was labeled with fluorescent cell trackers of a different color to permit easy identification and dynamic monitoring in situ. The cells were embedded in cell-compatible hydrogels, either alginate or combinations of alginate and Corning® PuraMatrix™ (a synthetic peptide hydrogel). Monodisperse alginate-PuraMatrix™ hydrogel spheroids were generated with a flow-focusing method in the device to form emulsions of liquid hydrogel droplets containing the cellular mixture, which were then docked and stabilized in the two-dimensional microdroplet array. The droplets were gelled by introducing a solution of 350 mM CaCl₂), which was perfused through the array chamber at a constant flow rate of 2 μl/hr over a period of 1-4 hours. Previous studies have reported that CaCl₂) concentrations up to 500 mM have little or no detrimental effect on cell health under short duration of calcium ion exposure.

Once the multicellular spheroids were formed, complete growth medium was continuously perfused at a rate of 20 μl/hr to maintain cell viability for the entire duration of the experiment. The continuous perfusion mimicked in vivo nutrient and drug delivery to tumors as opposed to the static delivery common to conventional cell culture systems. Finally, the integrated spheroid-trapping microarray was designed to hold individual hydrogel droplets in well-separated docking sites, to prevent fusion of the droplets, and to permit high-throughput screening by microscopic analysis.

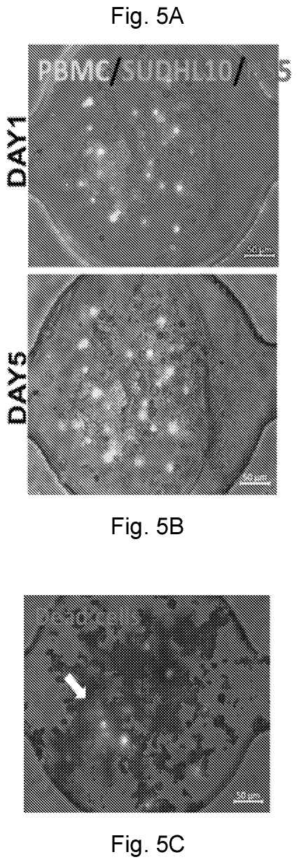

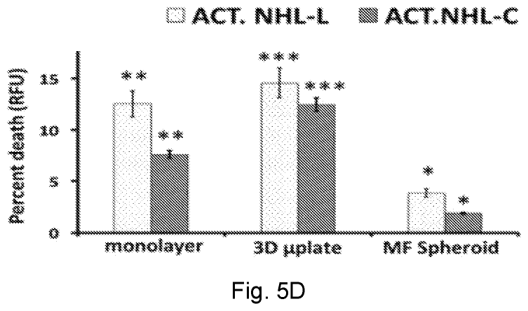

Other spheroids were formed using a combination of Diffuse Large B-Cell Lymphoma (DLBCL cell line SUDHL10) with fibroblasts (HS-5 cells) and peripheral blood mononuclear cells (PBMCs). The droplets contained a mixed hydrogel (alginate-PuraMatrix™) to support cell growth over periods of days to weeks. Rheological characterization and live-cell imaging (not shown) revealed that the combinatorial hydrogel matrix performed better than alginate alone, and also led to greater cell adhesion and spreading. The droplet-embedded cells were pre-labeled with different CFSE CellTrace™ fluorescent dyes (green or blue fluorescence) to visualize the different cell types and quantify their proliferation in the 3D micro-tumors. An exemplary spheroid is shown at days 1 and 5 in FIGS. 5A and 5B. Cell death in the spheroids was determined by treating the spheroids with ethidium homodimer on day 5 (FIG. 5C). This marker labels the nuclei of dead cells with red fluorescence, which is indicated by the arrow in FIG. 5C. The low level of dead cells showed that cells survived better in the lymphoma spheroid on-chip compared to other model systems (FIG. 5D). Furthermore, proteomic analysis of the perfusate media from spheroids demonstrated increased secretion of IL8 and cytolytic granzyme B upon treatment with immunomodulatory drug lenalidomide (L) in 3D NHL spheroids with active immune cells (not shown). This increase was significantly higher compared to lenalidomide-treated monocultures or 3D NHL spheroids containing inactive immune cells. Furthermore, the ability of the system to support encapsulation of primary patient-derived DLBCL cells was demonstrated (not shown).

### Example 2: Recovery of Individual Cell Spheroids

Device design and on-chip capture protocol are tested for isolation of a single cell spheroid from a two-dimensional array of cell spheroids. The microfluidic droplet generation device is used to prepare spheroids of MCF7 breast cancer cells. The inlets of the device are simultaneously fed using syringe pumps with mineral oil containing 3% v/v of Span 80 surfactant, a suspension of MCF7 cells at 7-10 million cells/mL and containing 2% w/v sodium alginate in Dulbecco's Modified Eagle Medium (DMEM) containing 10% v/v fetal bovine serum and 1% v/v antibiotic antimycotic solution, and a 4% w/v CaCl₂) solution. The flow rates are 300 μL/hr for the oil, 75 μL/hr for the cell suspension, and 10 μL/hr for the calcium solution. After the spheroids are produced, the flow of oil, cell suspension, and CaCl₂) solution is stopped, and the incubation chamber of the device is continuously perfused with cell culture medium by opening the first and second valves of the microchambers and slowly perfusing medium through the array chamber. The device then is placed in a cell culture incubator maintained at 37° C. and 95% air, 5% CO₂.

Optical microscopy is utilized to identify a single cell spheroid. Isolation of the single cell spheroid is accomplished by opening the pneumatic valves attached to the microchamber containing the desired spheroid, and the spheroid is displaced to an isolation channel in connection with the microchamber. The single isolated spheroid is further cultivated.

### Example 3: Generation of Hypoxic Tumor Environments In Vitro

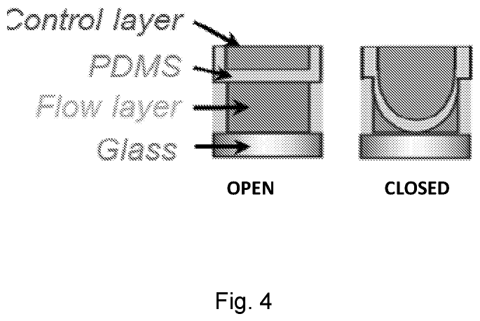

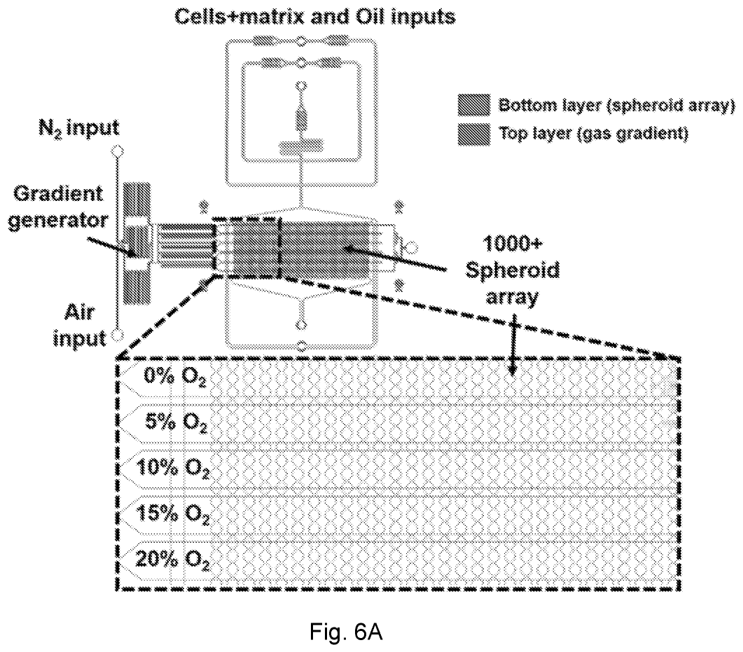

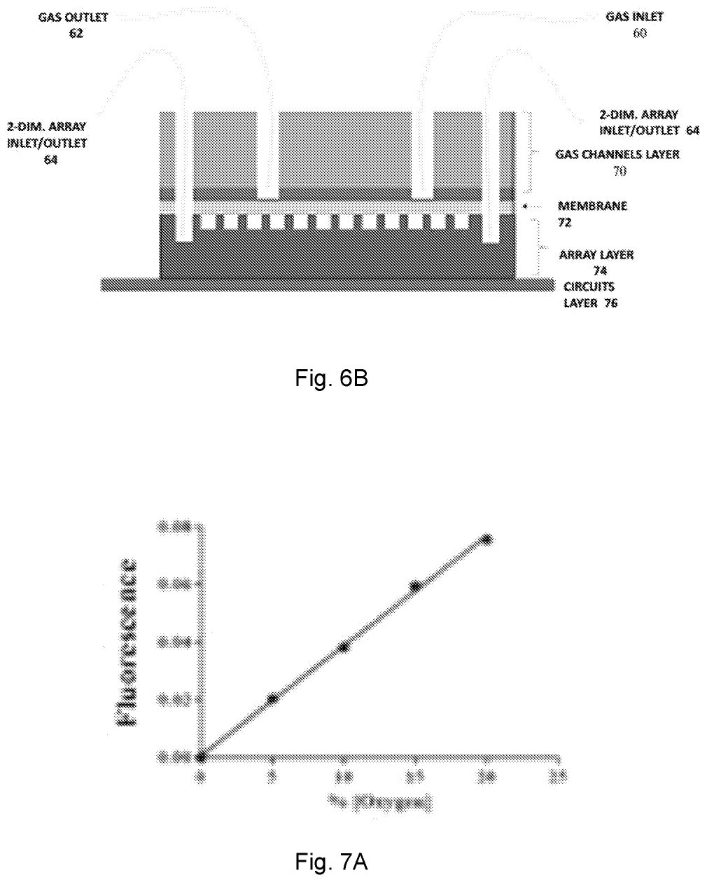

To simulate the hypoxia of a tumor microenvironment in vitro, a two-layer microfluidic device was used. The device contained a gas-permeable membrane separating a layer in which the microchamber array was embedded from a layer containing a gas gradient generator. The gas gradient generator depicted in the upper layer of the device of FIG. 4A was used to combine nitrogen and air, providing a range of oxygen concentrations from 0% to about 20%. The gas gradient was validated computationally and experimentally for different tumor types in vitro. The gradient generator operated according to known principles of gradient generation using a channel network that uses repetitive combination, mixing and splitting into separate channels, to yield mixtures with distinct compositions. The design utilized had a tree-shaped gradient generation network with inlets for perfusion of pure N₂ and air, and two stages of microchannel networks for splitting and re-mixing purposes. With the first stage, using a three-channel network, three concentrations were obtained at the branching point, which was then directed to a second stage of a broad mixing chamber of 10 mm×1.4 mm, providing five distinct final concentrations of oxygen from 1% to 5%. Following the gradient generation, five separate gas chambers were used, located in a separate device layer located on top of the docking array located in the first layer (see FIGS. 6A, 6B). The dimensions of each chamber were 41 mm×2 mm, with 400 μm gaps between the chambers, covering an area of the array chamber containing 200 spheroids.

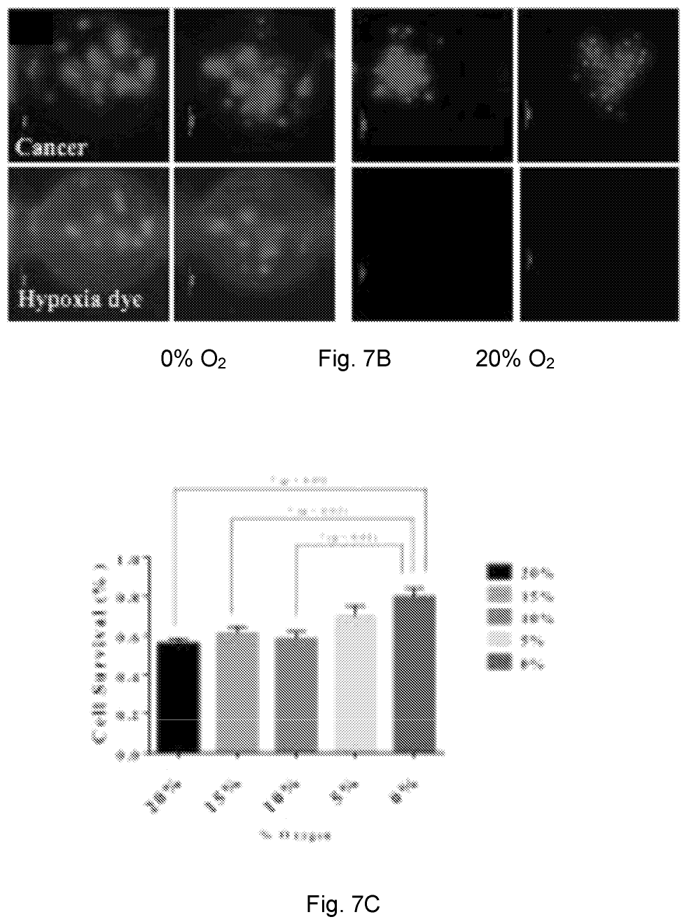

A feasibility study was carried out using five different O₂ concentrations across the droplet array. The spheroids were generated using MCF7 breast cancer cells combined with M1 macrophages. Differences were assessed using a ruthenium complex dye (FOXY-SGS, Ocean Optics, Fla., USA) using fluorescence microscopy. The fluorescence intensity in each gradient channel can be converted to an oxygen concentration based on the Stern-Volmer equation and quantitative represented (FIG. 7A). Assessment of hypoxic state of the cells was achieved by the addition of Image-iT Hypoxia reagent, a dynamic live-cell permeable dye that reversibly turns fluorescent in hypoxic environments of below 5% oxygen (see FIG. 7B, cancer cells stained in top row, bottom row showing hypoxic cells)). Cell death in MCF7 spheroids was determined under various oxygen concentrations in the presence of doxorubicin, a standard chemotherapy drug (FIG. 7C). Significant differences were found between full hypoxia (0% oxygen) and various higher oxygen levels (FIG. 6F).

1. A microfluidic device for the analysis and isolation of a plurality of cell spheroids, the device comprising:
a first layer comprising an array of microchambers or docking sites for storing and analyzing a plurality of cell spheroids in a liquid medium;
a second layer comprising a plurality of pneumatic channels, wherein the second layer overlays the first layer; and
one or more valves fluidically connected to each of said microchambers or docking sites; wherein the valves are disposed within said first layer and/or within said second layer; wherein each valve is selectively actuatable through one of said pneumatic channels, and wherein actuation of one or more of said valves opens a pathway for removal of a cell spheroid from the microchamber or docking sites fluidically connected to the one or more valves.

2. The microfluidic device of claim 1, wherein the first layer further comprises a cell spheroid production module; wherein the cell spheroid production module comprises:
a plurality of inlets for accepting solutions, cell suspensions, or oil;
a plurality of microfluidic channels fluidically connected to said inlets, said plurality of microfluidic channels comprising an oil channel and one or more cell suspension channels; and
a nozzle for forming aqueous microdroplets in oil, the nozzle inlet fluidically connected to said oil channel and at least one of said one or more cell suspension channels, and the nozzle outlet fluidically connected to said array of microchambers or docking sites.

3. The microfluidic device of claim 1 or claim 2, wherein two, three, or four valves are fluidically connected to each microchamber or docking site.

4. The microfluidic device of any of the preceding claims, wherein the valves comprise membrane valves.

5. The microfluidic device of any of the preceding claims, comprising a membrane disposed between the first and second layers of the device.

6. A microfluidic device for the analysis of a plurality of cell spheroids under a controlled atmosphere, the device comprising:
a first layer comprising an array of microchambers or docking sites for storing and analyzing a plurality of cell spheroids in a liquid medium;
a second layer comprising a plurality of pneumatic channels, wherein the pneumatic channels are coupled to at least one inlet and an outlet for the supply of gas to flow through the pneumatic channels, and wherein the second layer overlays the first layer; and
a gas-permeable membrane disposed between the first and second layers, wherein one or more of the pneumatic channels overlap with one or more said microchambers or docking sites, thereby enabling flow of gas from the pneumatic channels through the gas-permeable membrane and into said microchambers or docking sites, thereby providing a controlled atmosphere for cell spheroids disposed in said microchambers or docking sites.

7. The microfluidic device of claim 6, wherein the first layer further comprises a cell spheroid production module; wherein the cell spheroid production module comprises:
a plurality of inlets for accepting solutions, cell suspensions, or oil;
a plurality of microfluidic channels fluidically connected to said inlets, said plurality of microfluidic channels comprising an oil channel and one or more cell suspension channels; and
a nozzle for forming aqueous microdroplets in oil, the nozzle inlet fluidically connected to said oil channel and at least one of said one or more cell suspension channels, and the nozzle outlet fluidically connected to said array of microchambers or docking sites.

8. The microfluidic device of claim 6 or claim 7, wherein the second layer further comprises a gas gradient generator that provides a gradient of at least one component of said controlled atmosphere across the array of microchambers or docking sites.

9. The microfluidic device of any of the preceding claims, further comprising, one or more cell spheroids disposed in a microchamber or docking site of the array.

10. A system comprising the microfluidic device of claim 1 or claim 6 and a separate cell spheroid production device comprising:
a plurality of inlets for accepting solutions, cell suspensions, or oil;
a plurality of microfluidic channels fluidically connected to said inlets, said plurality of microfluidic channels comprising an oil channel and one or more cell suspension channels; and
a nozzle for forming aqueous microdroplets in oil, the nozzle inlet fluidically connected to said oil channel and at least one of said one or more cell suspension channels, and the nozzle outlet fluidically connected to an outlet;
wherein said outlet is capable of providing a plurality of cell spheroids from said cell spheroid production device through a fluidic coupling to said array of microchambers or docking sites of the microfluidic device.

11. A system comprising the microfluidic device of any of claims 1-5 or the system of claim 10, further comprising a controlled pneumatic pressure source connected to one or more of said pneumatic channels, the pressure source capable of selectively actuating one or more of said valves.

12. A method of analyzing a plurality of cell spheroids, the method comprising:
(a) providing the microfluidic device of any of claims 1-5, or the system of claim 10 or 11; an oil; a first aqueous suspension comprising one or more first cell types and one or more of a polymerization mediator or a polymerization precursor, and an extracellular biopolymer; and a second aqueous suspension comprising one or more of a polymerization mediator or a polymerization precursor, an extracellular biopolymer, and optionally one or more second cell types;
(b) inducing flow of said oil, first aqueous suspension, and second aqueous suspension in said device, whereby aqueous microdroplets are formed in the oil, each aqueous microdroplet comprising a single polymerized cell spheroid, each spheroid comprising a gel-forming polymer, one or more cell types, and said extracellular biopolymer;
(c) docking each spheroid in a unique microchamber or docking site of the array of the device; and
(d) analyzing one or more cell spheroids within the array for a period of time.

13. The method of claim 12, wherein one of said first and second cell types is a tumor cell.

14. The method of claim 12 or claim 13, wherein one of said first and second cell types is an immune cell.

15. The method of any of claims 12-14, wherein the first and/or second aqueous suspensions comprises an agent suspected of altering an interaction between the first and second cells or a functional property of said first or second cells.

16. The method of any of claims 12-15, further comprising pneumatically activating one or more of said first and/or second valves, whereby one or more cells or cell spheroids is collected from a microchamber or docking site of the device.

17. The method of claim 16, wherein said collected cell spheroid is removed from the device for further analysis, cultivation, expansion, or use in a therapeutic method.

18. The method of any of claims 12-17, wherein the spheroids are analyzed in step (d) for ability of an immune cell to bind or kill a cancer cell, or for a cancer cell to adhere to other cells of the spheroid, or for a cancer cell to migrate within the spheroid or to leave the spheroid.

19. A method of analyzing a plurality of cell spheroids under a controlled atmosphere, the method comprising:
(a) providing the microfluidic device of any of claims 6-9, or the system of claim 10 or 11; an oil; a first aqueous suspension comprising one or more first cell types and one or more of a polymerization mediator or a polymerization precursor, and an extracellular biopolymer; and a second aqueous suspension comprising one or more of a polymerization mediator or a polymerization precursor, an extracellular biopolymer, and optionally one or more second cell types;
(b) inducing flow of said oil, first aqueous suspension, and second aqueous suspension in said device, whereby aqueous microdroplets are formed in the oil, each aqueous microdroplet comprising a single polymerized cell spheroid, each spheroid comprising a gel-forming polymer, one or more cell types, and said extracellular biopolymer;
(c) docking each spheroid in a unique microchamber or docking site of the array of the device; and
(d) analyzing one or more cell spheroids within the array for a period of time.

20. The method of claim 19, wherein one of said first and second cell types is a tumor cell.

21. The method of claim 19 or claim 20, wherein one of said first and second cell types is an immune cell.

22. The method of any of claims 19-21, wherein the first and/or second aqueous suspensions comprises an agent suspected of altering an interaction between the first and second cells or a functional property of said first or second cells.

23. The method of any of claims 19-22, further comprising providing a controlled atmosphere through the pneumatic channels and optional gas gradient former of the second layer to cell spheroids disposed in one or more microchambers or docking site of the device.

24. The method of claim 23, wherein said controlled atmosphere is hypoxic.
